(19) United States
(12) Patent Application Publication
(10) Pub. No.: US 2007/0299379 A1
(43) Pub. Date: Dec. 27, 2007

(54) Massage Device

(76) Inventor: Xiuqun Luo, Dongguan (CN)

Correspondence Address: GLOBAL IP SERVICES, 7285 W. Eagle Court, Winton, CA, 95388, US

(21) Appl. No.: 11/625,255

(22) Filed: Jan. 19, 2007

Related U.S. Application Data
(63) Continuation-in-part of application No. 11/082,016, filed on Mar. 16, 2005, now abandoned.

(30) Foreign Application Priority Data
May 11, 2004 (CN) 2004200456092

(51) Int. Cl. A61H 15/00

(52) U.S. Cl. 601/112

(57) ABSTRACT

A massage device of the invention includes a base cover; a guiding device provided in the base cover and a moving base. The moving base is suspended above the guiding device. The moving base includes a bottom and a shield covered thereon to form a compartment. The moving base includes a massage system mounted on the shield of the moving base; a first transmission system to move the moving base along the guiding device and a second transmission system for driving the massage system, both the first and second transmission systems being contained in the compartment.

### CROSS-REFERENCE TO RELATED APPLICATION

This is a continuation in part patent application of the pending U.S. patent application Ser. No. 11/082,016, filed on Mar. 16, 2005. This patent application claims the domestic priority of the U.S. patent application Ser. No. 11/082,016 filed on Mar. 16, 2005, which claims the foreign priority of the Chinese patent application No. 2004200456092 filed on May 11, 2004.

### FIELD OF THE INVENTION

The present invention relates to massage devices with novel structures, and particularly to a massage device using worm to drive worm wheel so as to attain diversiform massage effects.

### BACKGROUND OF THE INVENTION

Conventional massage devices, as disclosed in Taiwan Patent No. 238543 and 435223, generally utilize worm to drive two correspondingly configured worm wheels to rotate relative to each other so as to make kneading components eccentrically coupled on the worm wheels to move circularly to perform massage function. At present, the massage devices are usually assembled on neck-massage parts of massage chairs or presented in an individual massage chair. However, the main drawback of the above-mentioned massage devices is that they only provide a single massage effect.

Hence, it is desired to provide a massage device to solve the above-mentioned problems.

### SUMMARY OF THE INVENTION

To overcome the above drawbacks of prior art, a main object of the present invention is to provide a massage device which can provide various massage effects.

To attain the above object, a massage device comprises a base cover; a guiding device comprising a plurality of guiding rails positioned in a middle region of the base cover; and a moving base which is suspended above the guiding rails of the guiding device; and which comprises a bottom and a shield covered on the bottom to form a compartment. The moving base further comprises a massage system mounted on the shield of the moving base; a first transmission system to move the moving base along the guiding rails of the guiding device and a second transmission system for driving the massage system, both the first and second transmission systems being contained in the compartment. The massage system comprises at least one rotation shelf which has a middle shaft bore defined therein and which has at least one kneading head mounted thereon. The second transmission system comprises a second motor, a second worm mechanically connected with the motor, at least one second worm wheel meshing with the second worm wheel and a wheel shaft coaxially connected with the at least second worm wheel. The worm wheel shaft of the second worm wheel has its top end mounted in the middle shaft bore of the rotation shelf of the massage system, the rotation shelf with its kneading head being rotated by the worm wheel shaft.

According to an embodiment of the invention, the base cover has a rack provided therein, and the first transmission system comprises a first motor, a first worm mechanically connected with the first motor, a first worm wheel meshing with the first worm, a small gear mounted under the first worm wheel, a big gear, an intermediary gear meshing with both the small gear and the big gear, and a driving gear meshing with the rack of the base cover. The first and second motors are set in a certain angle.

The moving base further comprises power equipment mounted between the bottom and the shield.

The number of the second wheels of the second transmission system is two, the two second worm wheels being simultaneously driven by the second worm, and the number of the rotation shelves of the massage system is two, the worm wheel shafts having their top ends mounted in the middle shaft bores of the respective rotation shelves.

The number of the kneading heads of the rotation shelf is two, and the kneading heads are symmetrically mounted on both sides of the middle shaft bore of the rotation shelf. In addition, the kneading heads are of a mushroom-shape.

The invention has the following advantages comparing to the prior art as: firstly, through the rotation of the kneading head transmitted by the second worm wheel, second worm and gear (rack) and movement of the moving base coordinated with guide rail and rack in bottom, curved guide rail made as the outline of people's back can better imitate the motion of manually massage to achieve the imitation effect of manually massage. Kneading and massage effect on different parts of body can make people feel more comfortable. The operation frequency of the massage device can be regulated as required by the person to give a gentle massage effect. The fixed bolt is added to the massage device to prevent the movement of the moving base when it is unused, which make it easy to move, deposit and have a high security to avoid unusual work electricity.

For the purpose of making the invention easier to understand, several particular embodiments thereof will now be described with reference to the appended drawings in which:

### DESCRIPTION OF THE DRAWINGS

FIG. 1 is a perspective view of a massage device according to an embodiment of the invention;

FIG. 2 is a perspective view of a moving base of the massage device shown in FIG. 1;

FIG. 3 is an exploded, perspective view of the massage device shown in FIG. 1.

### DETAILED DESCRIPTION OF THE INVENTION

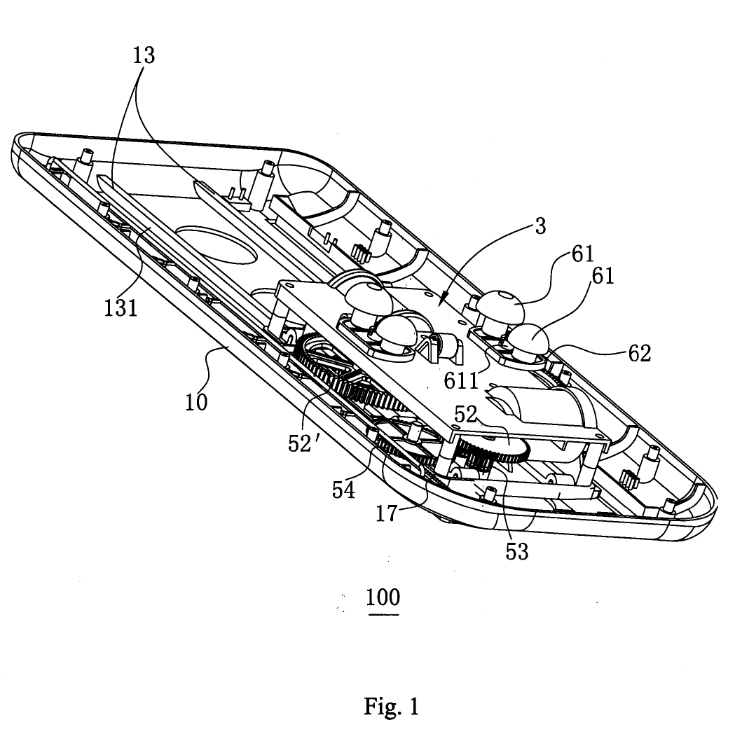

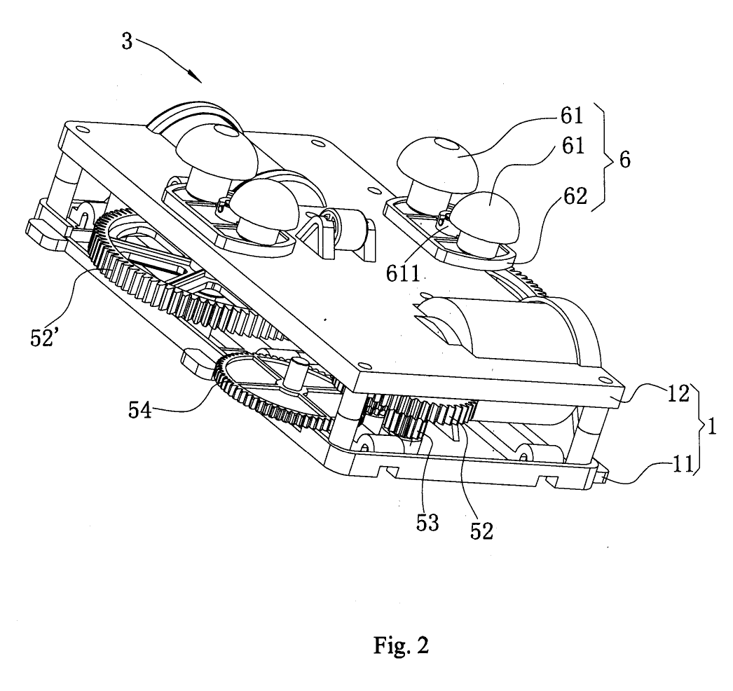

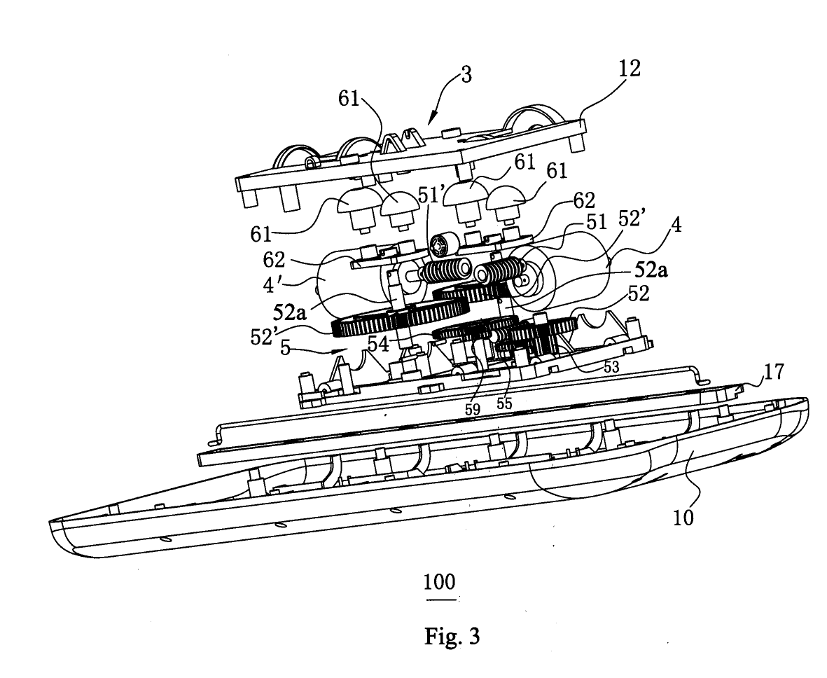

Referring to FIGS. 1-3, according to an embodiment of the invention, a massage device 100 comprises a base cover 10, a guide device 13 and a moving base 3. The base cover 10 comprises a rack 17 for driving the moving base 3 to move along the guide device 13. The guide device 13 is constituted by a plurality of guide rails 131 positioned in the middle region of the base cover 10. The moving base 3 comprises a bottom 11 and a shield 12 covered on the bottom 11 so as to collectively form a compartment or chassis 1. The moving base 3 is suspended above the guide device 13 and can move in an area defined by the guide device 13.

The moving base 3 further comprises a first transmission system for moving the moving base 3 along the guide device 3, a second transmission system and a massage system 6 for providing massage effect to a person. The first and second transmission systems are both mounted between the bottom 11 and the shield 12 of the moving base 3, namely, the both transmission systems are contained in the compartment 1 thereof. The first transmission system comprises a first motor 4, a first worm 51 mechanically connected with the first motor 4, a first worm wheel 52 meshing with the first worm 51, a small gear 53 mounted under the first worm wheel 52, a big gear 54, an intermediary gear 55 meshing with both the small gear 53 and the big gear 54 and a driving gear 59 meshing with the rack 17 of the base cover 10. The second transmission system comprises a second motor 4, a second worm 51′ mechanically connected with the motor 4′, a pair of second worm wheels 52′ meshing simultaneously with the second worm wheel 52′ and a pair of worm wheel shafts 52a coaxially connected with respective second worm wheels 52′.

More specifically, the first and second motors 4 and 4′ are set in a certain angle. The first motor 4 is provided with the first worm 51 on its output end and the second motor 4′ is provided with the second worm 51′ on its output end. The first worm wheel 52 is driven in-phase by the first worm 51 of the first motor 4 of the first transmission system. The pair of second worm wheels 52′ is driven in-phase by the second worm 51′ of the second motor 4′ of the second transmission system so that the two second worm wheels 52′ will rotate simultaneously and in an opposite direction when driven by the second worm 51′. The first and second worm wheels 52 and 52′ are all pivoted in the moving base 3 comparatively.

The massage system 6 is mounted on the shield 12 of the moving base 3. The massage system 6 comprises a pair of rotation shelves 62 each having a middle shaft bore 611 defined therein. Each rotation shelf 62 has a pair of kneading heads 61 mounted thereon. The two kneading heads 61 are symmetrically provided on both sides of the middle shaft bore 611 of the rotation shelf 62. In an embodiment, each of the kneading heads 61 has a shape of mushroom. Each worm wheel shaft 52a of respective second worm wheel 52′ has its top end mounted in the corresponding middle shaft bore 611 of each rotation shelf 62 of the massage system 6.

During operation, firstly, power is supplied for the first and second motors 4 and 4′; then the motor 4 and 4′ are driven to rotate so as to drive the first and the second transmission systems. The second worm 51′ is connected with the second motors 4′ and the second worm 51′ drives the pair of second worm wheels 52′ to make them rotate on both sides thereof. In the invention, the rotation shelves 62 are rotated along with the pair of second worm wheels 52′ respectively due to being fixed thereon. Then, the kneading heads 61 provided on respective rotation shelves 62 are rotated along with the rotation of rotation shelves 62. In the meantime, the kneading heads 61 are rotated by themselves. When a person has its back rested on the kneading heads 61, he will have a feeling of back-kneading by people's fingers. In the embodiment, because the two second worm wheels 52′ rotate in counter-direction and the kneading heads 61 are comparatively set on the rotation shelves 62, the pressure exerted to the person can be changed so as to achieve an imitated manual massage effect. When the first worm wheel 52 rotates, the rotation is transmitted with speed-down to the big gear 54 through the small gear 53 and the intermediary gear 55. The driving gear 59 provided under the big gear 54 is thus joggled with the rack 17 so as to drive the moving base 3 move on back of person and attain an imitated way of manual massage. The guide rails 131 are used for guiding the moving base 3 and making its movement smoothly. The two motors 4, 4′ are controlled by circuit of the massage device 100 to make them both or solely work, thus achieving various massage effects.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A massage device comprising:
a base cover;
a guiding device comprising a plurality of guiding rails positioned in a middle region of the base cover; and
a moving base which is suspended above the guiding rails of the guiding device; and which comprises a bottom and a shield covered on the bottom to form a compartment; wherein
the moving base further comprises a massage system mounted on the shield of the moving base; a first transmission system to move the moving base along the guiding rails of the guiding device and a second transmission system for driving the massage system, both the first and second transmission systems being contained in the compartment, wherein
the massage system comprises at least one rotation shelf which has a middle shaft bore defined therein and which has at least one kneading head mounted thereon;
the second transmission system comprises a second motor, a second worm mechanically connected with the motor, at least one second worm wheel meshing with the second worm wheel and a wheel shaft coaxially connected with the at least second worm wheel;
the worm wheel shaft of the second worm wheel has its top end mounted in the middle shaft bore of the rotation shelf of the massage system, the rotation shelf with its kneading head being rotated by the worm wheel shaft.

2. The massage device as claimed in claim 1, wherein the base cover has a rack provided therein, and the first transmission system comprises a first motor, a first worm mechanically connected with the first motor, a first worm wheel meshing with the first worm, a small gear mounted under the first worm wheel, a big gear, an intermediary gear meshing with both the small gear and the big gear, and a driving gear meshing with the rack of the base cover.

3. The massage device as claimed in claim 2, wherein the first and second motors are set in a certain angle.

4. The massage device as claimed in claim 1, wherein the moving base further comprising power equipment mounted between the bottom and the shield.

5. The massage device as claimed in claim 1, wherein the number of the second wheels of the second transmission system is two, the two second worm wheels being simultaneously driven by the second worm, and the number of the rotation shelves of the massage system is two, the worm wheel shafts having their top ends mounted in the middle shaft bores of the respective rotation shelves.

6. The massage device as claimed in claim 1, wherein the number of the kneading heads of the rotation shelf is two, and the kneading heads are symmetrically mounted on both sides of the middle shaft bore of the rotation shelf.

7. The massage device as claimed in claim 6, wherein the kneading heads are of a mushroom-shape.
